(19) United States
(12) Patent Application Publication
(10) Pub. No.: US 2010/0031604 A1
(43) Pub. Date: Feb. 11, 2010

(54) DOOR PANEL

(75) Inventors: Norio Nakajima, Tokyo (JP); Ryoji Uto, Tokyo (JP); Eri Uchikoshi, Hyogo (JP)

Correspondence Address: DARBY & DARBY P.C., P.O. BOX 770, Church Street Station, New York, NY, 10008-0770, US

(73) Assignee: CATERPILLAR JAPAN LTD., Tokyo (JP)

(21) Appl. No.: 12/519,265

(22) PCT Filed: Jul. 4, 2008
(86) PCT No.: PCT/JP2008/062167

§ 371 Date: Jun. 15, 2009

(30) Foreign Application Priority Data
Dec. 7, 2007 (JP) 2007-316860

(51) Int. Cl. E06B 3/00; E04B 1/00

(52) U.S. Cl. 52/784.1; 52/750

(57) ABSTRACT

A door panel that permits formation of small ventilation holes therein while ensuring adequate rigidity is provided. The door panel includes an outer panel, an inner panel, and a perforated ridge-and-furrow plate. The outer panel has openings, and the inner panel has openings. The inner panel is formed by means of press molding so as to have an uneven surface with recessed portions and a raised portion, with the raised portion protruding away from the outer panel and the recessed portions recessed towards and fixed to the inner surface of the outer panel. The perforated ridge-and-furrow plate is attached to the reverse side of the inner panel. The perforated ridge-and-furrow plate is a punching plate that is already provided with numerous small, circular ventilation holes, or with ventilation holes arranged in a mesh or a honeycomb shape. The perforated ridge-and-furrow plate includes alternating furrow portions and ridge portions formed in the region that corresponds to the openings of the inner panel.

### CROSS-REFERENCE TO PRIOR APPLICATION

This is a U.S. national phase application under 35 U.S.C. §371 of International Patent Application No. PCT/JP2008/062167 and claims the benefit of Japanese Application No. 2007-316860, filed Dec. 7, 2007. The contents of the above applications are incorporated herein in their entirety. The International Application was published in Japanese on Jun. 11, 2009 as WO2009/072317 A1 under PCT Article 21(2).

### TECHNICAL FIELD

The present invention relates to a door panel that is provided with an outer panel and an inner panel.

### BACKGROUND OF THE INVENTION

FIG. 9 illustrates a hydraulic excavator 10, which is a work machine. The hydraulic excavator 10 includes a lower structure 11, an upper structure 12, a cab 13, a work equipment 14, and a power system 15 that includes an engine. The cab 13, the work equipment 14, and the power system 15 are mounted on the upper structure 12, which is rotatably mounted on the lower structure 11. The power system 15 is covered by a top cover 16, side doors 17, and other such components. Each side door 17 is mounted by hinges, which are attached to one of the lateral ends of the side door 17, so as to be capable of opening and closing, and secured in the closed state by means of a latching device 18 at the other lateral end of the side door 17.

Examples of structures of a door panel of this type include a double-panel cover unit structure including an outer panel and an inner panel, wherein the inner panel is formed by means of press molding so as to have an uneven surface protruding away from and recessed towards the outer panel, and is affixed to the outer panel (e.g. See Patent Document 1: Japanese Laid-open Patent Publication No. 9-228412 (page 3, and FIGS. 6-8).

A side door 17 with a double-panel structure illustrated in FIGS. 10 and 11 has been proposed. The side door 17 includes a door panel 20 designed with high-heat tolerance with improved ventilation ability so as to withstand severe heat. The door panel 20 includes an outer panel 21 and an inner panel 23, which are conjoined together by an adhesive or other appropriate means. Ventilation hole clusters 25a, each of which consists of grouped small ventilation holes 25 in a mesh or grid-like shape, are formed in the outer panel 21, and large ventilation openings that do not interfere with the ventilation hole clusters 25a are formed in the inner panel 23.

The aforementioned door panel 20 designed with high-heat tolerance has a structure wherein the small ventilation holes 25 are formed in a mesh directly in the outer panel 21. In cases where the outer panel 21 is thick (1.0 mm or thicker) to be used for a work machine, it is difficult to form small ventilation holes 25 therein. In addition, there is the possibility of the outer panel 21 itself being so large as to present limitations in the kinds of available processing, such as the size of the processing machine.

Furthermore, depending on the usage of the door panel 20, there is the possibility of the door panel 20 being used in an environment with a lot of dispersed powder dust, and a request received to form small, meshed ventilation holes in the outer panel 21 in order to prevent such dust from being sucked into the work machine. As it is difficult to form holes of this small size with the conventional processing technology, such a request is usually dealt with by attaching a mesh to the outer panel 21 from the reverse side.

Such a need may also be met by providing a thin plate having ventilation holes between the outer panel and the inner panel. However, should the ventilation holes required to be extremely small in size, i.e. not greater than 3.0 mm in diameter, it is still necessary to make the plate substantially thin, resulting in the possibility of insufficient rigidity.

In order to solve the above problems, an object of the invention is to provide a door panel that permits formation of small ventilation holes therein while ensuring adequate rigidity.

### SUMMARY OF THE INVENTION

Claim 1 of the present invention relates to a door panel including an outer panel having an opening; an inner panel affixed to the inner surface of the outer panel and having an opening; and a perforated ridge-and-furrow plate affixed to the inner panel and provided, at least in the region that corresponds to the opening of the inner panel, with ventilation holes as well as with a furrow portion and a ridge portion.

According to the present invention, the perforated ridge-and-furrow plate of the door panel according to the present invention is formed by shaping a punching plate.

The perforated ridge-and-furrow plate of the door panel according to of the present invention includes a flange portion having a shape that corresponds to the peripheral shape of the opening of the inner panel.

According to the present invention, the perforated ridge-and-furrow plate, which is affixed to the inner panel, is provided, at least in the region that corresponds to the opening of the inner panel, with ventilation holes as well as with a furrow portion and a ridge portion. Therefore, by means of the perforated ridge-and-furrow plate, the door panel can be provided with small holes easily, compared with cases where small holes are formed directly in the outer panel. Furthermore, the furrow portion and the ridge portion increase the rigidity and thereby ensure sufficient strength of the perforated ridge-and-furrow plate, even if a plate that is substantially thin to permit formation of small ventilation holes is used.

According to the present invention, the perforated ridge-and-furrow plate can be produced inexpensively by using a conventionally available punching plate.

In the present invention, the flange portion is formed in a shape that corresponds to the peripheral shape of the opening of the inner panel enables the perforated ridge-and-furrow plate to be easily as well as assuredly conjoined with the inner panel.

### BRIEF DESCRIPTION OF THE DRAWINGS

FIG. 1 is an exploded perspective view of a door panel according to an embodiment of the present invention.

FIG. 2 is an external view of the door panel.

FIG. 3 is an internal view of the door panel.

FIG. 4 is a sectional view taken along the line IV-IV of FIG. 3.

FIG. 5 is an enlarged sectional view of the part represented by V in FIG. 4.

FIG. 6 is an enlarged sectional view of the part represented by VI in FIG. 4.

FIG. 7 is a perspective view of a perforated ridge-and-furrow plate used in the door panel.

FIG. 8 is a plan view of a work machine provided with the door panel.

FIG. 9 is a perspective view of a conventional work machine.

FIG. 10 is an external view of a door panel based on which the aforementioned door panel is formed.

FIG. 11 is a sectional view taken along the line XI-XI of FIG. 10.

### DETAILED DESCRIPTION OF THE INVENTION

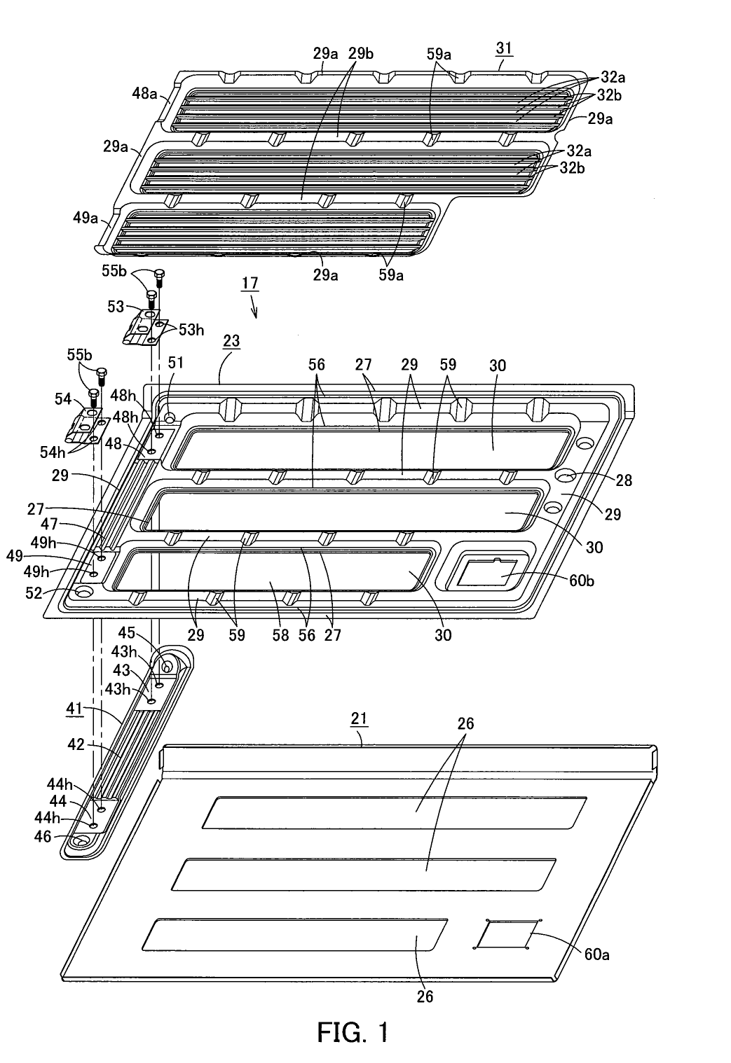

Next, the present invention is explained hereunder, referring to an embodiment thereof shown in FIGS. 1 to 8.

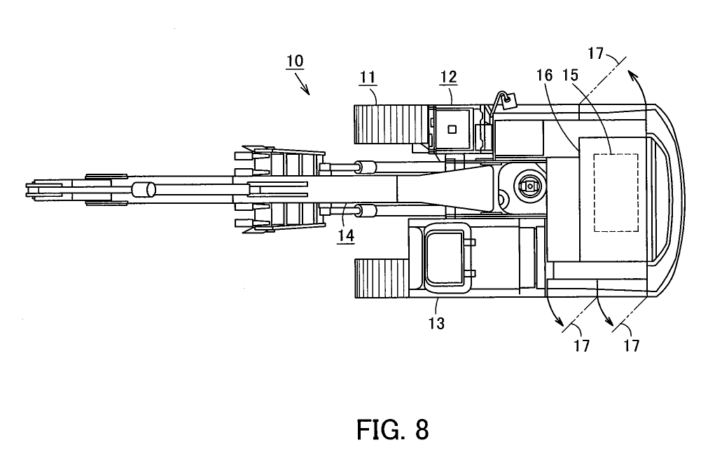

FIG. 8 illustrates a hydraulic excavator 10, which is a work machine. The hydraulic excavator 10 includes a lower structure 11, an upper structure 12, a cab 13, a work equipment 14, and a power system 15 that includes an engine. The cab 13, the work equipment 14, and the power system 15 are mounted on the upper structure 12, which is rotatably mounted on the lower structure 11. The power system 15 is covered by a top cover 16, side doors 17, and other such components. Each side door 17 is mounted by hinges so as to be capable of opening and closing, and maintained in the closed state by means of a latching device 18, which will be explained later.

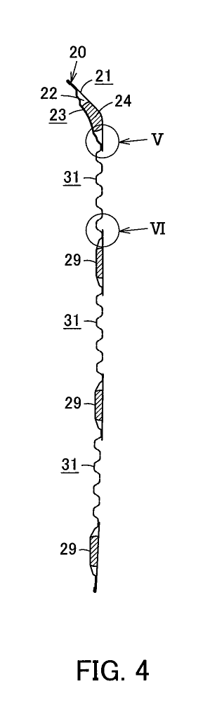

FIGS. 1 to 7 illustrate a door panel 20 of a side door 17. As illustrated in FIG. 4, the door panel 20 includes an outer panel 21, an inner panel 23, and a foamed material 24. The inner panel 23 is formed by means of press molding so as to have an uneven surface with recessed portions and raised portions. The recessed portions are fixed to the inner surface of the outer panel 21, and a space 22 is formed between the raised portions and the inner surface of the outer panel 21 and filled with the aforementioned foamed material 24.

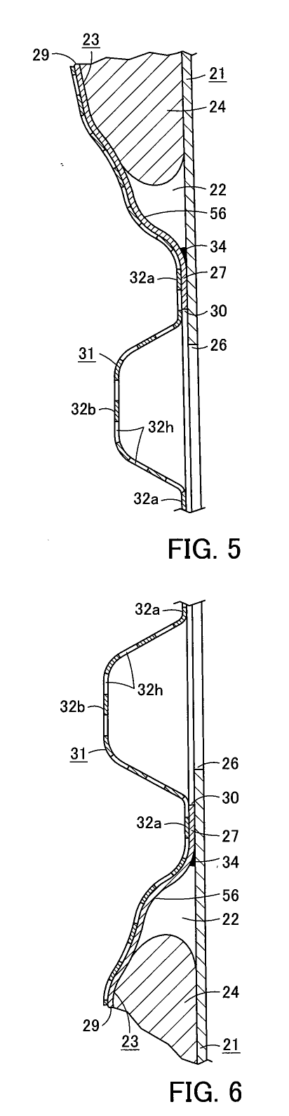

As illustrated in FIGS. 5 and 6, the outer panel 21 has a thickness ranging from 1.2 to 5.0 times that of the inner panel 23. In other words, an iron plate that is thinner than the outer panel 21 is used to form the inner panel 23. For example, if the outer panel 21 is an iron plate with a thickness of 1.2 mm, it is desirable to use a thin iron plate with a thickness of, for example, 0.6 or 0.8 mm to form the inner panel 23 in order to obtain sufficient strength and workability, which are reciprocal properties. As such a sheet metal is suitable for a single-press molding, various recessed portions and raised portions explained later are formed by pressing in order to obtain a prescribed strength.

The foamed material 24 is formed by heating an unactivated foaming sheet of a foaming material, which is attached to the inner surface of the outer panel 21 or the inner surface of the inner panel 23, so that the heated foaming material is activated and expands inside the space 22 between the outer panel 21 and the inner panel 23. A highly expandable foaming rubber-base sound absorbing material that has an approximately 20-fold volumetric thermal expansion coefficient may desirably be used as the foaming material. It is desirable to conduct the heating of the foaming material during the baking finish process using a baking finish heating apparatus.

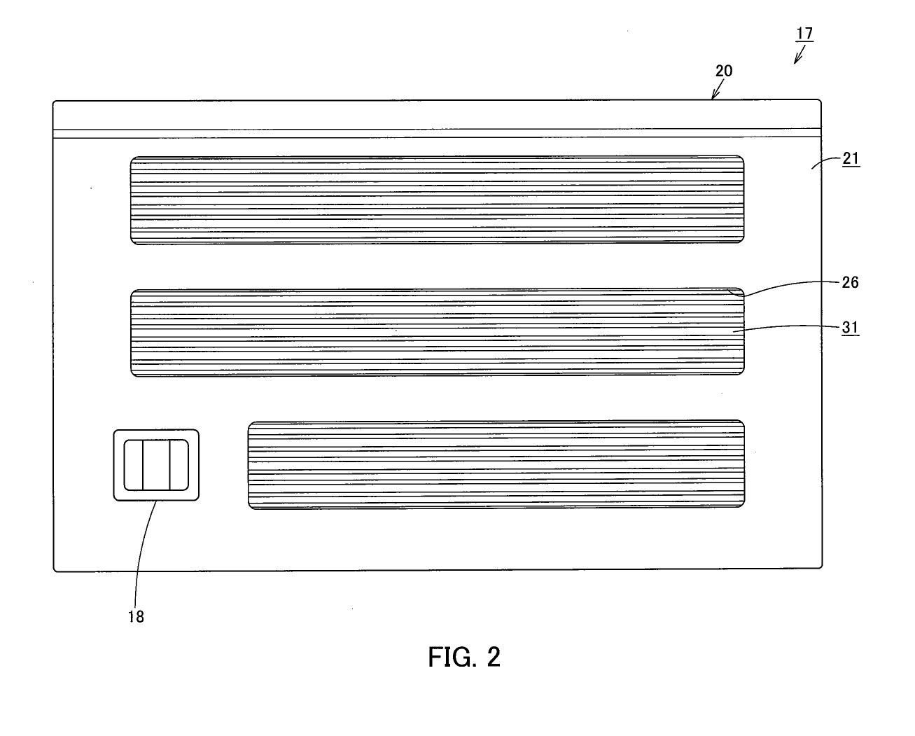

As illustrated in FIGS. 1 and 2, a plurality of rectangular openings 26 are punched through the outer panel 21. The openings 26 are parallelly arranged one above the other at regular intervals.

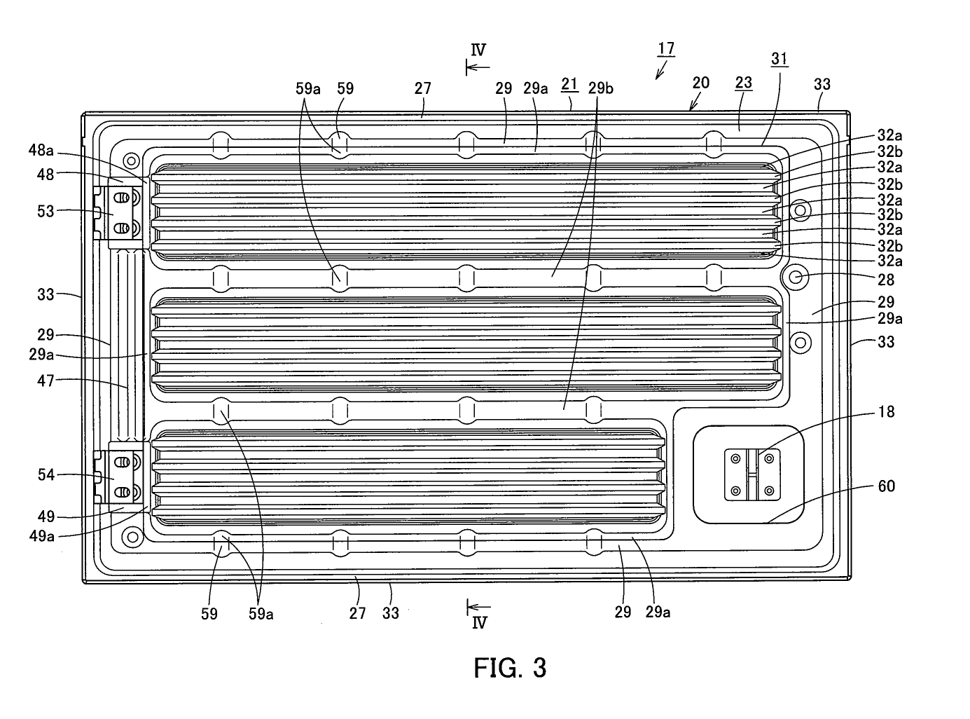

As illustrated in FIGS. 1 and 3, the inner panel 23 has recessed adhering portions 27,28, which are joined to the outer panel 21, and a raised portion 29 bulging from the adhering portions 27,28. In the same manner as the openings 26 of the outer panel 21, rectangular openings 30 are punched through the inner panel 23 in such a manner that each opening 30 is enclosed by the raised portion 29 of the inner panel 23.

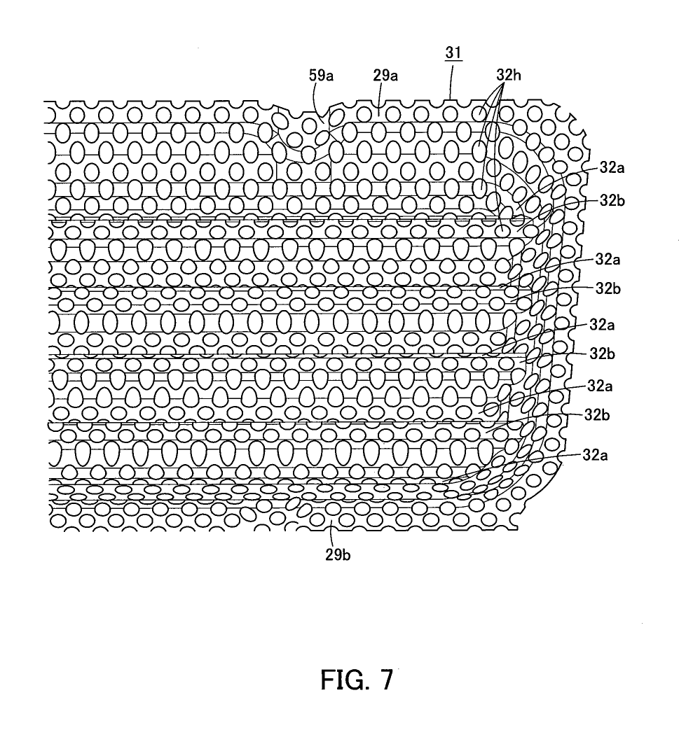

As illustrated in FIGS. 1 to 3, a perforated ridge-and-furrow plate 31 is attached to the reverse side of the inner panel 23 over the openings 30. As illustrated in FIG. 7, the perforated ridge-and-furrow plate 31 is already provided with numerous small, circular ventilation holes 32h, or with ventilation holes arranged in a mesh or a honeycomb shape.

A commercially available punching plate with ventilation holes 32h formed over the entire plate may be used as the perforated ridge-and-furrow plate 31. In an alternative structure, the perforated ridge-and-furrow plate 31 may be formed by processing a plate member by using a processing machine for press punching, drilling, electrical discharge machining, laser processing, etc. so as to form ventilation holes 32h at least in the region that corresponds to the openings 30 of the inner panel 23.

The perforated ridge-and-furrow plate 31 is further provided with alternating furrow portions 32a and ridge portions 32b, which are formed in the region that corresponds to the openings 30 of the inner panel 23.

As illustrated in FIG. 3, the peripheral edge of the outer panel 21 is provided with a hemmed portion 33, which is formed by hemming, in other words by folding the peripheral edge of the outer panel 21 so as to curl over the entire peripheral edge of the inner panel 23 and then pressing down the folded part.

As illustrated in FIGS. 5 and 6, an adhesive 34 is applied between the outer panel 21 and the adhering portions 27 of the inner panel 23. Along the hemmed portion 33, the outer panel 21 and the inner panel 23 are joined and sealed together by the adhesive 34 applied therebetween. The adhesive 34 may desirably be a paste-type structural adhesive having both viscous and thermosetting properties.

As illustrated in FIG. 1, an internal reinforcing plate 41 for mounting hinges is immovably sandwiched between the outer panel 21 and the inner panel 23 in the state where the inner panel 23 is positioned on and affixed to the inner surface of the outer panel 21.

The internal reinforcing plate 41 is provided at the middle portion thereof with a corrugated adhering portion 42 including alternating ridges and furrows. Nut mounting surface portions 43,44 are respectively formed continuously with one end and the opposing end of the corrugated adhering portion 42. A plurality of bolt insertion holes 43h or 44h are formed in each nut mounting surface portion 43 or 44. A positioning fitting portion 45 and a positioning fitting portion 46, both of which have a concave shape, are formed adjacent to the nut mounting surface portions 43,44, respectively.

At the location corresponding to the internal reinforcing plate 41, the inner panel 23 is provided with a corrugated adhering portion 47 including alternating ridges and furrows. The corrugated adhering portion 47 is formed at the middle part of the hinge-attaching end of the raised portion 29 of the inner panel 23. Hinge mounting surface portions 48,49 are respectively formed adjacent to one end and the opposing end of the corrugated adhering portion 47. Each hinge mounting surface portion 48 or 49 is a flat surface and has a plurality of bolt insertion holes 48h or 49h formed therein. A positioning fitting portion 51 and a positioning fitting portion 52, both of which are in the shape of a protrusion protruding downward, are formed adjacent to the hinge mounting surface portions 48,49, respectively.

The two positioning fitting portions 45,46 of the internal reinforcing plate 41 have different dimensions, and, correspondingly, the positioning fitting portions 51,52 of the inner panel 23, too, have different dimensions. The positioning fitting portion 45 and the positioning fitting portion 51, which are respectively formed at mutually corresponding locations on the internal reinforcing plate 41 and the inner panel 23, fit to each other in a male-female engagement. The positioning fitting portion 46 and the positioning fitting portion 52, which are respectively formed at another pair of mutually corresponding locations on the internal reinforcing plate 41 and the inner panel 23, fit to each other in a male-female engagement.

Hinges 53,54, each of which has a plurality of bolt insertion holes 53h or 54h, respectively abut the hinge mounting surface portions 48,49 of the inner panel 23.

Nuts (not illustrated) are conjoined with the reverse surface of each nut mounting surface portion 43 or 44 of the internal reinforcing plate 41 beforehand, by bonding or welding. Each nut is provided concentrically with each respective bolt insertion hole 43h or 44h.

The bolts 55b inserted through the bolt insertion holes 53h,54h of the hinges 53,54 and the bolt insertion holes 48h,49h of the hinge mounting surface portions 48,49 of the inner panel 23 are screwed into the nuts, which are conjoined with the reverse surface of the nut mounting surface portions 43,44 of the internal reinforcing plate 41. Thus, the hinges 53,54 are fastened by tightening these nuts and bolts 55b. By means of these hinges 53,54, the door panel 20 is mounted, so as to be capable of opening and closing, on a frame (not illustrated) provided at the machine body on the upper structure 12.

As illustrated in FIGS. 5 and 6, the inner panel 23 includes the raised portion 29 bulging from the adhering portions 27, which are recessed and in direct contact with the outer panel 21. A reinforcing deformed portion 56 is formed in a step-like shape along the middle of each sloping side of the raised portion 29. As illustrated in FIG. 1, the raised portion 29 and each reinforcing deformed portion 56 are formed in an endless manner along the recessed adhering portions 27.

As illustrated in FIGS. 1 and 3, the raised portion 29 of the inner panel 23 is so formed as to bulge from the adhering portions 27. Of the raised portion 29, portions extending straight in the lateral direction are provided with reinforcing indentations 59. The reinforcing indentations 59 are formed across the laterally extending portions of the raised portion 29.

As illustrated in FIG. 1, mounting holes 60a, 60b for mounting a latching device 18 are formed in the outer panel 21 and the inner panel 23, respectively. The latching device 18 is a mechanism for locking the door panel 20 in the closed state by engagement with a hooking member, i.e. a striker, protruding from the frame (not illustrated) provided at the machine body on the upper structure 12.

As illustrated in FIGS. 1, 3, and 7, the perforated ridge-and-furrow plate 31 includes a flange portion 29a and a partition portion 29b. The flange portion 29a has an uneven shape that corresponds to the peripheral shape of the openings 30 of the inner panel 23.

To be more specific, the flange portion 29a and the partition portion 29b are formed to correspond to the raised portion 29 of the inner panel 23. Recessed portions 48a, 48b are formed in the flange portion 29a so as to correspond to the hinge mounting surface portions 48, 49 of the inner panel 23. Furthermore, indentations 59a are formed in the flange portion 29a and the partition portion 29b so as to correspond to the reinforcing indentations 59 of the inner panel 23.

As illustrated in FIG. 3, the flange portion 29a and the partition portion 29b of the perforated ridge-and-furrow plate 31 are attached to the reverse surface of the inner panel 23. The method of attaching the perforated ridge-and-furrow plate 31 may be selected from among various methods, including a method for joining the flange portion 29a and the partition portion 29b to the reverse surface of the inner panel 23 by means of an adhesive, a method for welding the flange portion 29a and the partition portion 29b directly to the reverse surface of the inner panel 23, and a method for fitting mounting holes formed in the flange portion around screws that are fixed to the reverse surface of the inner panel beforehand by means of stud welding, and tightening the screws with nuts.

Next, a production process of the door panel 20 is explained.

The foaming material is attached to the inner surface of the raised portion 29 of the inner panel 23 or to the inner surface of the outer panel 21. The internal reinforcing plate 41 for mounting hinges is joined, by means of the thermosetting adhesive, to the reverse surface of the raised portion 29 of the inner panel 23 at a location in the proximity of one of the lateral ends of the inner panel 23, and the perforated ridge-and-furrow plate 31 is fixed to the inner panel 23 over the openings 30. Then, the thermosetting adhesive 34 is applied to the surfaces of the adhering portions 27 of the inner panel 23 and the internal reinforcing plate 41 that are to abut the outer panel 21. Thereafter, the outer panel 21 and the inner panel 23 are positioned and layered one on top of the other, and the peripheral edge of the outer panel 21 is affixed along the hemmed portion 33 so that the inner panel 23, the perforated ridge-and-furrow plate 31, and the internal reinforcing plate 41 are joined to the inner surface of the outer panel 21.

Thereafter, the inner panel 23, the perforated ridge-and-furrow plate 31, and the internal reinforcing plate 41 are bonded to the outer panel 21 by heating the adhesive 34 using the baking finish heating apparatus to harden the adhesive 34. Then, as illustrated in FIGS. 4 to 6, the foaming material is expanded to fill the space 22 with the foamed material 24 by heating using the baking finish heating apparatus. Furthermore, the paint that has been sprayed beforehand onto the outer surface of the outer and inner panels 21,23 is baked thereon by heating using the baking finish heating apparatus.

For example, thermal hardening of the adhesive 34 is conducted by heating for 5 minutes at 150° C.; formation of the foamed material 24 by expansion by heating for 20 minutes at 150° C.; and baking finish by heating for 20 minutes at 180° C. to 200° C. Such heating can be performed by using a conventional baking finish heating apparatus.

Finally, as illustrated in FIGS. 1 and 3, the hinges 53,54 are fastened to the hinge mounting surface portions 48,49 of the inner panel 23 and also to the internal reinforcing plate 41 by means of the bolts 55b, and the latching device 18 is attached to the mounting hole 60a of the outer panel 21 and the mounting hole 60b of the inner panel 23.

Next, the functions and effects obtained from the embodiment described above are explained hereunder.

The hollow structure with a closed cross section formed of the outer panel 21 and the inner panel 23, which is thinner than the outer panel 21, can make the entire door panel 20 lighter. Furthermore, as the closed cross section of this hollow structure has sufficient height, being formed of the inner panel 23 and the outer panel 21 with a thickness greater than that of the inner panel 23, i.e. 1.2 to 5.0 times thicker than the inner panel 23, the door panel has sufficient strength against an external impact. Therefore, the embodiment provides a door panel that is light in weight and has sufficient strength at inexpensive cost.

To be more specific, the hollow structure with a closed cross section formed of the outer panel 21 and the inner panel 23 ensures sufficient strength. Furthermore, as illustrated in FIGS. 5 and 6, the inner panel 23 includes the raised portion 29 bulging from the adhering portions 27, which are in direct contact with the outer panel 21. A stepped reinforcing deformed portion 56 is formed along the middle of each sloping side of the raised portion 29. By gaining the height of the raised portion 29 by means of the stepped reinforcing deformed portions 56, the strength of the inner panel 23 is further improved compared with a door panel that is merely provided with a raised portion 29, because the geometric moment of inertia relative to the direction of the load is proportional to the height cubed. As a result, the strength of the entire door panel is improved.

Furthermore, the foamed material 24 filling the space between the outer panel 21 and the inner panel 23 is capable of absorbing sound and thereby effectively damping sound generated from the door panel itself and, consequently, provides high damping effect to reduce noise.

As illustrated in FIGS. 5 and 6, the perforated ridge-and-furrow plate 31, which is affixed to the inner panel 23, is provided, at least in the region that corresponds to the openings 30 of the inner panel 23, with ventilation holes 32h as well as with alternating furrow portions 32a and ridge portions 32b. Therefore, by means of the perforated ridge-and-furrow plate 31, the door panel 20 can be provided with small holes easily, compared with cases where small holes are formed directly in the outer panel 21. Furthermore, the alternating furrow portions 32a and ridge portions 32b increase the rigidity and thereby ensure sufficient strength of the perforated ridge-and-furrow plate 31, even if a plate that is substantially thin to permit formation of small ventilation holes 32h is used.

In other words, even with a processing machine that is not capable of processing a large outer panel 21, such a perforated ridge-and-furrow plate 31 as the one illustrated in FIG. 7 can be processed so as to be provided therein with numerous miniscule ventilation holes 32a that are small enough to trap and thereby prevent dispersed powder dust from being sucked into the work machine.

By forming a conventionally available punching plate into a shape that corresponds to the uneven shape of the inner panel 23 as illustrated in FIG. 7, the perforated ridge-and-furrow plate 31 can be produced inexpensively.

As described above, processing a plate already provided with miniscule holes formed therein into an uneven shape enables the formation of a perforated ridge-and-furrow plate 31 with improved rigidity. Furthermore, such a perforated ridge-and-furrow plate 31 attached to the reverse side of the inner panel 23 over the openings 30 ensures adequate ventilation ability and rigidity.

For example, if a punching metal provided with minuscule holes not more than 3 mm in diameter is processed into an uneven shape as illustrated in FIG. 7, forming such a shape not only improves the rigidity but also increases the total aperture area of the holes, compared with the holes formed in a flat plate. Depending on the usage of the door panel 20, there is the possibility of the door panel 20 being used in an environment with a lot of dispersed powder dust, and a request received to form small, meshed ventilation holes in the outer panel 21 in order to prevent such dust from being sucked into the work machine. However, the configuration described above is capable of meeting such a requirement.

As illustrated in FIG. 3, the flange portion 29a having an uneven shape that corresponds to the peripheral shape of the openings 30 of the inner panel 23 enables the perforated ridge-and-furrow plate 31 to be easily as well as assuredly conjoined with the inner panel 23.

In forming the flange portion 29a, working efficiency can be further improved by forming the flange portion 29a simultaneously during the pressing process to form the perforated ridge-and-furrow plate 31 into an uneven shape having the furrow portions 32a and the ridge portions 32b.

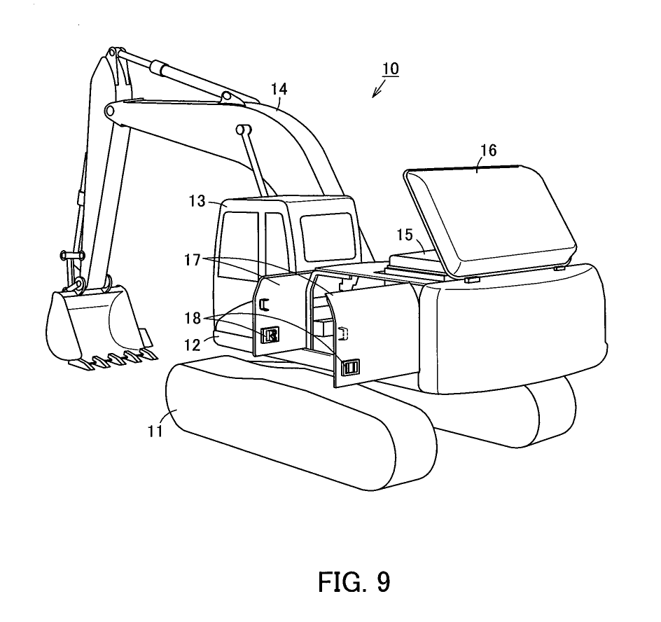

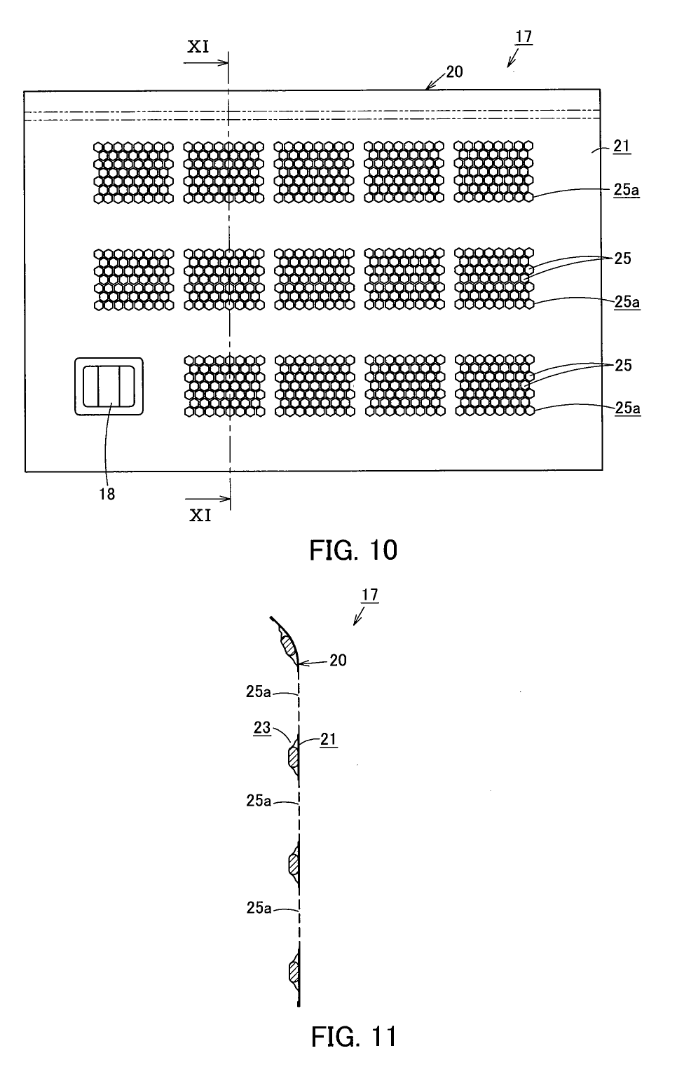

The present invention is applicable to a door panel of a work machine, such as a hydraulic excavator illustrated in FIG. 8 or FIG. 9.

1. A door panel comprising:
an outer panel having an opening;
an inner panel affixed to the inner surface of the outer panel and having an opening; and
a perforated ridge-and-furrow plate affixed to the inner panel and provided, at least in the region that corresponds to the opening of the inner panel, with ventilation holes as well as with a furrow portion and a ridge portion.

2. A door panel as claimed in claim 1, wherein:
the perforated ridge-and-furrow plate is formed by shaping a punching plate.

3. A door panel as claimed in claim 1, wherein:
the perforated ridge-and-furrow plate further includes a flange portion having a shape that corresponds to the peripheral shape of the opening of the inner panel.
